(19) United States
(12) Patent Application Publication
(10) Pub. No.: US 2016/0021105 A1
(43) Pub. Date: Jan. 21, 2016

(54) Secure Voice Query Processing

(71) Applicant: Sensory, Incorporated, Santa Clara, CA (US)

(72) Inventors: Bryan Pellom, Erie, CO (US); Todd F. Mozer, Los Altos Hills, CA (US)

(21) Appl. No.: 14/748,820

(22) Filed: Jun. 24, 2015

Related U.S. Application Data
(60) Provisional application No. 62/024,623, filed on Jul. 15, 2014.

(51) Int. Cl. H04L 29/06; G10L 17/00; G06F 17/30; G06K 9/00

(52) U.S. Cl. CPC H04L 63/0861; G06K 9/00006; G06K 9/00221; G10L 17/005; G06F 17/30657; H04L 63/105

(57) ABSTRACT

Techniques for securely processing voice queries are provided. In one embodiment, a computing device can receive speech data corresponding to a voice query uttered by a user and, in response to the speech data, determine the user's identity and a query type of the voice query. The computer device can further retrieve a first security level associated with the user's identity and a second security level associated with the query type. The computing device can then determine, based on the first security level and the second security level, whether the voice query should be processed.

### CROSS REFERENCES TO RELATED APPLICATIONS

The present application claims the benefit and priority under 35 U.S.C. 119(e) of U.S. Provisional Application No. 62/024,623, filed Jul. 15, 2014, entitled “SECURELY PROCESSING VOICE QUERIES USING FACE-BASED AUTHENTICATION,” the entire contents of which are incorporated herein by reference for all purposes.

### BACKGROUND

In recent years, voice command-and-control has become a popular feature on mobile devices such as smartphones, tablets, smartwatches, and the like. Generally speaking, this feature allows a user to interact with his/her mobile device in a hands-free manner in order to access information and/or to control operation of the device. For example, according to one implementation, the user can say a predefined trigger phrase, immediately followed by a query or command phrase (referred to herein as a “voice query”), such as “will it rain today?” or “call Frank.” The processor of the user's mobile device will typically be listening for the predefined trigger phrase in a low-power, always-on modality. Upon sensing an utterance of the trigger phrase, the mobile device can cause the voice query to be recognized, either locally on the device or remotely in the cloud. The mobile device can then cause an appropriate action to be performed based on the content of the voice query and can return a response to the user.

One issue with existing voice command-and-control implementations is that they generally assume a given device is only used by a single user (e.g., the device's owner), and thus all voice queries submitted to the device can be processed using the same level of security. However, in many real-life scenarios, these assumptions do not hold true. For instance, consider a scenario where user A and user B work in the same office, and user A leaves her smartphone on her desk before leaving to attend a meeting. If user B picks up user A's phone while she is gone and asks “will it rain today?”, this query would be relatively harmless to process/answer. But, if user B asks “what is my bank account balance?”, such a query should require a higher level of security and some authentication that the individual asking the question is, in fact, an authorized user of the device (e.g., user A).

Further, many new types of devices are coming to market that support voice command-and-control, but are specifically designed to be operated by multiple users. Examples of such devices include voice-enabled thermostats, lighting controls, security systems, audio systems, set-top boxes, televisions, and the like. For these types of multi-user devices, it would be desirable to have granular control over the kinds of voice queries that are deemed allowable for each user.

### SUMMARY

Techniques for securely processing voice queries are provided. In one embodiment, a computing device can receive speech data corresponding to a voice query uttered by a user and, in response to the speech data, can determine the user's identity and a query type of the voice query. The computer device can further retrieve a first security level associated with the user's identity and a second security level associated with the query type. The computing device can then determine, based on the first security level and the second security level, whether the voice query should be processed.

A further understanding of the nature and advantages of the embodiments disclosed herein can be realized by reference to the remaining portions of the specification and the attached drawings.

### BRIEF DESCRIPTION OF THE DRAWINGS

FIG. 1 depicts a system environment that supports secure voice query processing according to an embodiment.

FIG. 2 depicts a flowchart for defining security levels for device users and voice query types according to an embodiment.

FIG. 3 depicts a flowchart for carrying out secure voice query processing based on the security levels defined in FIG. 2 according to an embodiment.

FIG. 4 depicts a flowchart for carrying out secure voice query processing that leverages face-based authentication according to an embodiment.

FIG. 5 depicts an exemplary computing device according to an embodiment.

### DETAILED DESCRIPTION

In the following description, for purposes of explanation, numerous examples and details are set forth in order to provide an understanding of specific embodiments. It will be evident, however, to one skilled in the art that certain embodiments can be practiced without some of these details, or can be practiced with modifications or equivalents thereof.

1. Overview

The present disclosure describes techniques that can be performed by a voice-enabled computing device (e.g., a computer system, a mobile device, a home automation device, etc.) for more securely processing voice queries. At a high level, these techniques involve categorizing users of the computing device according to various security levels. For example, the head of a household may be categorized as having high security clearance, while a child within the household may be categorized as having low security clearance. The techniques further involve categorizing different types of voice queries according to the same, or related, security levels. For example, “will it rain today” may be categorized as a low-security query, while “what's my bank account balance” may be categorized as high-security query.

Then, at the time a voice query is received from a given user, the computing device can identify the user and retrieve the identified user's security level. In various embodiments, the computing device can identify the user using any one (or more) of a number of known authentication techniques, such as voice-based authentication, face-based authentication, fingerprint-based authentication, and so on. The computing device can also recognize the content of the voice query and retrieve the recognized query's security level. Finally, based on the user security level and the query security level, the computing device can determine whether the voice query should be acted upon or not. For instance, if the user's security level is higher than the security level defined for the query, the computing device can proceed with processing the query. However, if the user's security level is lower than the security level defined for the query, the computing device can return a response indicating that the query cannot be processed. In this way, the voice command-and-control feature of the computing device can be used by, and securely shared among, multiple users (e.g., friends, co-workers, family members, etc.) that may have different access rights/privileges with respect to the device.

In certain embodiments, as part of determining whether the voice query can be acted upon (i.e., processed), the computing device can determine a threshold level of user authentication that is required based on the query's security level (e.g., is voice-based authentication sufficient, or are additional forms of authentication required, such as face, PIN, etc.). The computing device can then prompt the user to authenticate himself/herself using the additional authentication method(s) as needed in order to proceed with query processing. Further, in some embodiments, the step of identifying/authenticating the user can be performed in parallel with the step of recognizing the voice query in order to ensure low latency operation. These and other aspects of the present disclosure are described in additional detail in the sections that follow.

2. System Environment

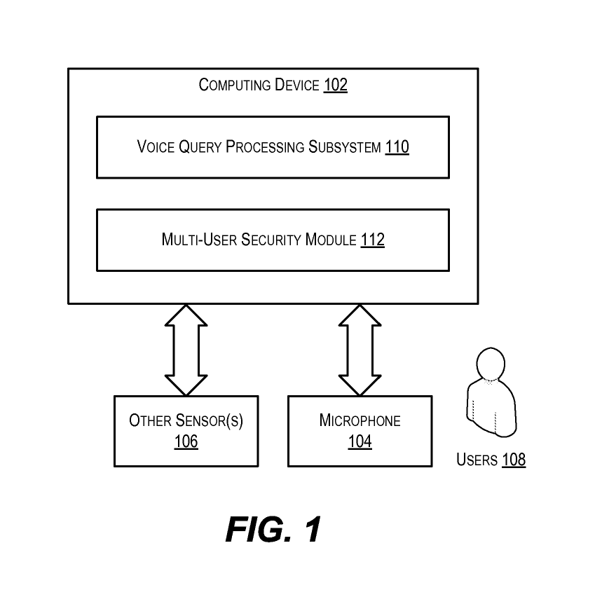

FIG. 1 depicts a high-level system environment 100 for securely processing voice queries according to an embodiment. As shown, system environment 100 includes a computing device 102 that is communicatively coupled with a microphone 104 and one or more other sensors 106. In one set of embodiments, computing device 102 can be a mobile device, such as a smartphone, a tablet, or a wearable device (e.g., smartwatch, smart armband/wristband, etc.). Computing device 102 can also be any other type of electronic device known in the art, such as a desktop or laptop computer system, a smart thermostat, a home automation/security system, an audio system, a set-top box, a television, etc.

Microphone 104 is operable for capturing speech uttered by one or more users 108 of computing device 102. Other sensors 106 are operable for capturing other types of signals/data from users 108, such as face data (via a camera), fingerprint data (via a fingerprint sensor), and so on. In some embodiments, microphone 104 and other sensors 106 can be integrated directly into computing device 102. For example, in a scenario where computing device 102 is a smartphone or smartwatch, microphone 104 and other sensors 106 can correspond to cameras, microphones, etc. that are built into the device. In other embodiments, microphone 104 and other sensors 106 may be resident in another device or housing that is separate from computing device 102. For example, in a scenario where computing device 102 is a home automation or security device, microphone 104 and other sensors 106 may be resident in a home fixture, such as a front door. In this and other similar scenarios, data captured via microphone 104 and other sensors 106 can be relayed to computing device 102 via an appropriate communication link (e.g., a wired or wireless link).

In addition to computing device 102, microphone 104, and other sensors 106, system environment 100 includes a voice query processing subsystem 110, which may run on computing device 102 (as shown in the example of FIG. 1) or on another device/system. Generally speaking, voice query processing subsystem 110 can receive speech data (e.g., a voice query) captured from a user 108 via microphone 104, convert the speech data into a computational format, and apply known speech recognition techniques to the converted speech data in order to recognize the content of the voice query. Voice query processing subsystem 110 can then cause computing device 102 to act upon the recognized query (e.g., manipulate a control, launch an application, retrieve information, etc.) and return an appropriate response to the originating user.

As noted in the Background section, existing voice command-and-control implementations like voice query processing subsystem 110 of FIG. 1 generally operate on the assumption that a given device is used by a single user (or a single class of users that all have the same security privileges with respect to the device). As a result, such existing implementations are not capable of selectively processing (or refusing to process) voice queries based on the identity of the user that uttered the query and/or the query content. This can pose a potential security risk in environments where multiple users can interact with the device via its voice query capability.

To address the foregoing and other similar issues, system environment 100 also includes a novel multi-user security module 112. Although module 112 is shown in FIG. 1 as being a part of computing device 102, in alternative embodiments module 112 can run, either entirely or partially, on another system or device that is communicatively coupled with computing device 102, such as a remote/cloud-based server. As described in further detail below, multi-user security module 112 can maintain a first set of mappings that associate enrolled users of computing device 102 (e.g., users 108) with a first set of security levels, and a second set of mappings that associate various types of voice queries recognizable by subsystem 110 with a second set of security levels (which may be the same as, or related to, the first set of security levels). Multi-user-security module 112 can subsequently use these first and second sets of mappings during device runtime in order to determine, on a per-user and per-query basis, whether the voice queries received by computing device 102 are allowed to be processed or not.

By way of example, assume that an adult in a household is associated with security level “10” and a child in the household is associated with security level “5.” Further assume that any voice query relating to “interior lighting control” (e.g., turning on lights, turning off lights, etc.) is associated with security level “7.” In this scenario, if the adult utters a voice query to “turn off the living room lights,” multi-user security module 112 can determine that the adult's security level exceeds the security level of the uttered query, and thus can allow voice query processing subsystem 110 to proceed with processing the query (and thereby cause the living room lights to turn off). On the other hand, if the child issues the same voice query “turn off the living room lights,” multi-user security module 112 can determine that the child's security level is below the security level of the uttered query, and thus can disallow query processing.

It should be appreciated that system environment 100 of FIG. 1 is illustrative and not intended to limit the embodiments of the present disclosure. For instance, as mentioned above, voice query processing subsystem 110 and multi-user security module 112 of computing device 102 can be configured to run, either entirely or partially, on a remote device/system. Further, the components of system environment 100 can include other subcomponents or features that are not specifically described/shown. One of ordinary skill in the art will recognize many variations, modifications, and alternatives.

2. Security Level Definition Workflow

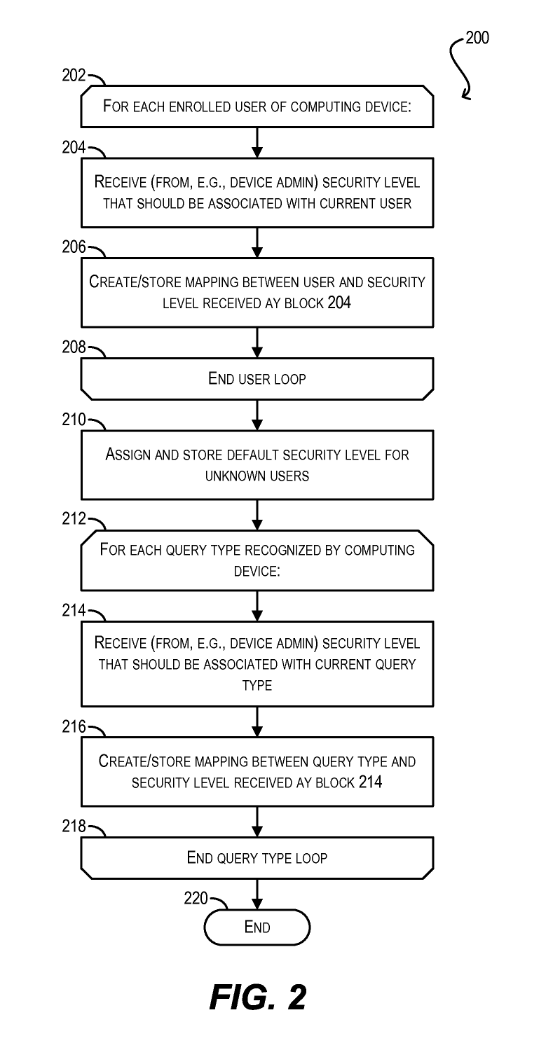

FIG. 2 depicts a workflow 200 that can be performed by multi-user security module 112 of FIG. 1 for setting up initial [user, security level] and [query type, security level] mappings for computing device 102 according to an embodiment. Workflow 200 assumes that (1) a set of enrolled users that are identifiable via, e.g., an authentication submodule of security module 112 and (2) a set of voice query types that are recognizable by voice query processing subsystem 110 have already been defined for computing device 102.

At block 202, multi-user security module 112 can enter a loop for each enrolled user in the set of enrolled users. Within the loop, multi-user security module 112 can receive (from, e.g., a device administrator) an indication of a security level that should be associated with the current user (block 204). In one embodiment, these security levels can be selected from a numerical scale, where higher numbers indicate higher (i.e., more secure) security levels. In other embodiments, the security levels can be selected from any predefined set of values or elements.

At block 206, multi-user security module 112 can create/store a mapping between the current user and the security level received at block 204. The current loop iteration can subsequently end (block 208), and multi-user security module 112 can return to block 202 in order to process additional enrolled users as needed.

Once the user loop has been completed, multi-user security module 112 can assign a default security level to unknown users (e.g., users that cannot be identified as being in the set of enrolled users) (block 210). In a particular embodiment, this default security level can correspond to the lowest possible user security level.

Then, at block 212, multi-user security module 112 can enter a second loop for each query type in the set of voice query types recognizable by computing device 102. Within this second loop, multi-user security module 112 can receive (from, e.g., the device administrator) an indication of a security level that should be associated with the current query type (block 214). In a particular embodiment, these query security levels can be selected from a scale or value/element set that is identical to the user security levels described above. Alternatively, the query security levels can be entirely different from, but capable of being compared to, the user security levels.

At block 216, multi-user security module 112 can create/store a mapping between the current query type and the security level received at block 214. Finally, at block 218, the current loop iteration can end and multi-user security module 112 can return to block 212 in order to process additional query types as needed. Once all query types have been processed, workflow 200 can end (block 220).

3. Secure Voice Query Processing Workflow

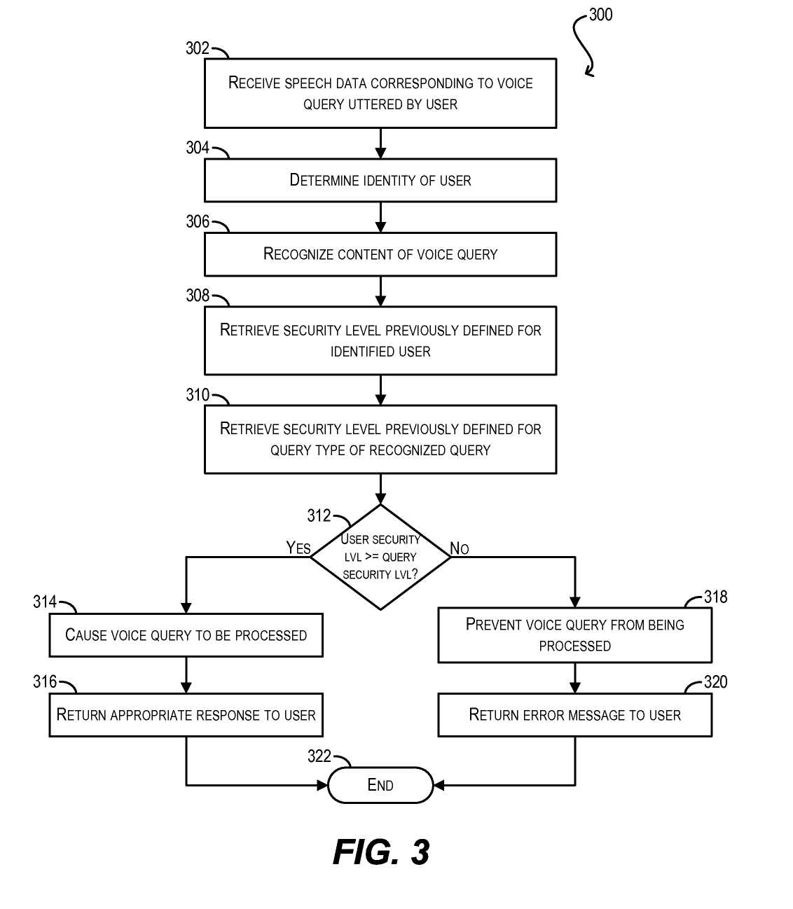

FIG. 3 depicts a workflow 300 can that can be performed by computing device 102 (and, in particular, multi-user security module 112 and voice query processing subsystem 110 of device 102) for securely processing voice queries according to an embodiment. Workflow 300 assumes that [user, security level] and [query type, security level] mappings have been defined per workflow 200 of FIG. 2.

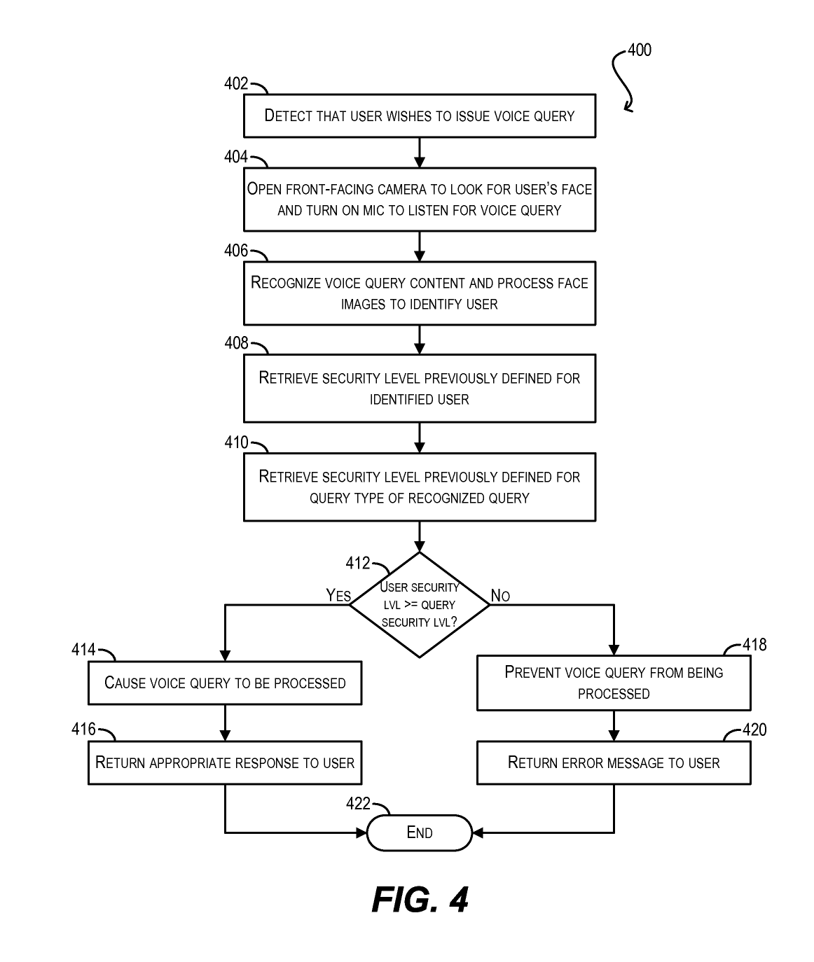

Starting with block 302, computing device 102 can receive (via, e.g., microphone 104) speech data corresponding to a voice query uttered by a user. In response to receiving the speech data, multi-user security module 112 can identify the user as being a particular enrolled user, or as being an unknown user (block 304). As mentioned previously, module 112 can use any of a number of known authentication techniques to carry out this identification, such as voice-based authentication, face-based authentication, fingerprint- based authentication, and so on. A particular embodiment that makes use of face-based authentication is described with respect to FIG. 4 below.

Further, at block 306, voice query processing subsystem 110 can recognize the content of the voice query, and can determine a particular query type that the voice query belongs to. For example, if the recognized voice query is “turn off on the living room lights,” the associated query type may be “interior lighting control.”

At blocks 308 and 310, multi-user security module 112 can retrieve the security level previously defined for the identified user (per blocks 202-210 of workflow 200), as well as the security level previously defined for the determined query type (per blocks 212-218 of workflow 200). Then, at block 312, multi-user security module 112 can compare the user security level with the query security level.

If the user security level exceeds (or is equal to) the query security level, multi-user security module 112 can conclude that the user is authorized to issue this particular voice query, and thus can cause the voice query to be processed/executed (block 314). In response to the query execution, computing device 102 can return an appropriate response to the user (block 316).

However, if the user security level is below the query security level, multi-user security module 112 can conclude that the user is not authorized to issue this particular voice query, and thus can prevent the voice query from being processed/executed (block 318). As part of this alternate flow, computing device 102 can return an error message to the user indicating that the user does not have sufficient privileges to issue the voice query (block 320). Finally, at block 322, workflow 300 can end.

It should be appreciated that workflow 300 is illustrative and various modifications are possible. For example, in certain embodiments, multi-user security module 112 may not immediately process the voice query if the user security level exceeds or is equal to the query security level at block 312. Instead, multi-user security module 112 may ask the user to authenticate himself/herself using one or more additional authentication methods before proceeding with query processing. These additional authentication requirements may be triggered by a number of different factors, such as the type of the voice query, the security level of the voice query, the degree of difference between the compared security levels, the degree of confidence in the user authentication, and/or the type of user authentication originally performed. For example, if the voice query being issued by the user is an extremely sensitive query, multi-user security module 112 may ask that the user authenticate himself/herself via additional methods in order to make sure that he/she is an authorized user.

Further, although the user identification performed at block 304 and the query content recognition performed at block 306 are shown as being executed serially, in certain embodiments there steps may be performed in parallel. In other words, voice query processing subsystem 110 can begin query recognition while multi-user security module 112 is in the process of attempting to identify the user. By performing these steps concurrently, the amount of latency perceived by the user for the overall voice query processing task can be substantially reduced. One of ordinary skill in the art will recognize other modifications, variations, and alternatives.

4. Secure Voice Query Processing Workflow with Face-Based Authentication

FIG. 4 depicts a workflow 400 that specifically leverages face-based authentication to perform user identification within the secure voice query processing workflow of FIG. 3. Starting with block 402, computing device 102 can detect that a user wishes to issue a voice query. In one embodiment, computing device 102 can perform this detection via a motion sensing system that determines that the user has moved the device towards his/her face. Such a motion sensing system can operate in a low-power, always-on fashion, and thus may be constantly looking for this type of movement. In alternative embodiments, computing device 102 can perform this detection based on the occurrence of a predefined trigger event (e.g., an incoming call/text/email, user opens an application, etc.) or other types of criteria (e.g., changes in acceleration or environmental conditions, etc.).

At block 404, computing device 102 can briefly open a front-facing camera on the device and can look for the user's face. Computing device 102 can also simultaneously turn on microphone 104 to begin listening for a voice query from the user.

At block 406, computing device 102 can buffer the speech input received at block 404 and can begin recognizing the voice query content using voice query processing subsystem 110. At the same time, multi-user security module 112 can process the face image(s) received via the front-facing camera in order to identify the user.

Once the voice query has been recognized and the user has been identified via his/her face, the remaining steps of workflow 400 can be substantially similar to blocks 308-322 of workflow 300. For example, multi-user security module 112 can retrieve the security levels defined for the user and the voice query (blocks 408, 410), compare the security levels against each other (block 412), and then take appropriate steps, based on that comparison, to allow (or disallow) processing of the voice query (blocks 414-422).

It should be appreciated that workflow 400 is illustrative and various modifications are possible. For example, in certain embodiments, the face-based authentication performed at blocks 404-406 can be combined with other biometric authentication techniques, such as voice-based authentication, in order to identify the user. The advantages of this layered approach are that a higher level of security can be achieved, and the authentication process can be more environmentally flexible (e.g., work in loud environments, low light environments, etc.).

In further embodiments, computing device 102 can automatically fall back to a user-prompted authentication method (e.g., PIN or password entry) if the device is unable to locate the user's face via its front-facing camera. One of ordinary skill in the art will recognize other variations, modifications, and alternatives.

5. Exemplary Computing Device

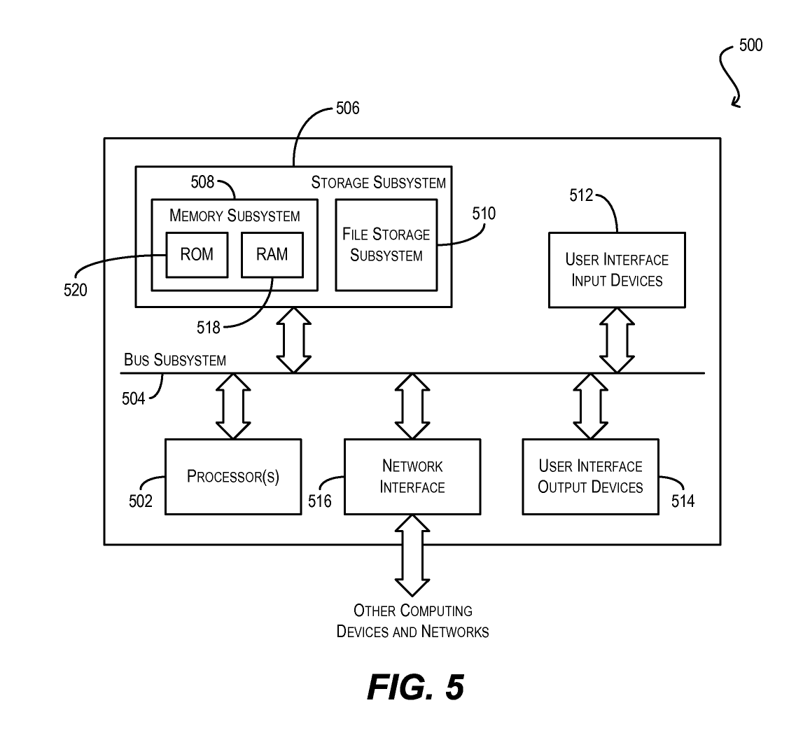

FIG. 5 depicts an exemplary computing device 500 that may be used to implement, e.g., device 102 of FIG. 1. As shown, computing device 500 can include one or more processors 502 that communicate with a number of peripheral devices via a bus subsystem 504. These peripheral devices can include a storage subsystem 506 (comprising a memory subsystem 508 and a file storage subsystem 510), user interface input devices 512, user interface output devices 514, and a network interface subsystem 516.

Bus subsystem 504 can provide a mechanism for letting the various components and subsystems of computing device 500 communicate with each other as intended. Although bus subsystem 504 is shown schematically as a single bus, alternative embodiments of the bus subsystem can utilize multiple busses.

Network interface subsystem 516 can serve as an interface for communicating data between computing device 500 and other computing devices or networks. Embodiments of network interface subsystem 516 can include wired (e.g., coaxial, twisted pair, or fiber optic Ethernet) and/or wireless (e.g., Wi-Fi, cellular, Bluetooth, etc.) interfaces.

User interface input devices 512 can include a touch-screen incorporated into a display, a keyboard, a pointing device (e.g., mouse, touchpad, etc.), an audio input device (e.g., a microphone), and/or other types of input devices. In general, use of the term “input device” is intended to include all possible types of devices and mechanisms for inputting information into computing device 500.

User interface output devices 514 can include a display subsystem (e.g., a flat-panel display), an audio output device (e.g., a speaker), and/or the like. In general, use of the term “output device” is intended to include all possible types of devices and mechanisms for outputting information from computing device 500.

Storage subsystem 506 can include a memory subsystem 508 and a file/disk storage subsystem 510. Subsystems 508 and 510 represent non-transitory computer-readable storage media that can store program code and/or data that provide the functionality of various embodiments described herein.

Memory subsystem 508 can include a number of memories including a main random access memory (RAM) 518 for storage of instructions and data during program execution and a read-only memory (ROM) 520 in which fixed instructions are stored. File storage subsystem 510 can provide persistent (i.e., non-volatile) storage for program and data files and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computing device 500 is illustrative and many other configurations having more or fewer components than shown in FIG. 5 are possible.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. For example, although certain embodiments have been described with respect to particular process flows and steps, it should be apparent to those skilled in the art that the scope of the present invention is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the invention as set forth in the following claims.

What is claimed is:

1. A method comprising:
receiving, by a computing device, speech data corresponding to a voice query uttered by a user;
determining, by the computing device, the user's identity and a query type of the voice query;
retrieving, by the computing device, a first security level associated with the user's identity and a second security level associated with the query type; and
determining, by the computing device based on the first security level and the second security level, whether the voice query should be processed.

2. The method of claim 1 wherein determining the user's identity comprises applying a voice-based authentication technique to the speech data received from the user.

3. The method of claim 1 wherein determining the user's identity comprises applying a fingerprint-based authentication technique to fingerprint data received from the user.

4. The method of claim 1 wherein determining the user's identity comprising applying a face-based authentication technique to one or more images of the user's face captured at the time of receiving the speech data.

5. The method of claim 4 wherein the one or more images of the user's face are captured by:
sensing, via a motion sensing system of the computing device, that the user has moved the computing device towards the user's face; and
in response to the sensing, turning on a camera of the computing device.

6. The method of claim 5 wherein the motion sensing system is continuously looking for movement of the computing device while in a low-power state.

7. The method of claim 1 wherein determining the user's identity comprising applying a combination of two or more user authentication techniques.

8. The method of claim 1 wherein determining the query type of the voice query comprises:
recognizing the content of the voice query; and
identifying a query type associated with recognized content.

9. The method of claim 1 wherein determining the user's identity and determining the query type are performed in parallel.

10. The method of claim 1 wherein the first and second security levels are user-configurable.

11. The method of claim 1 wherein determining whether the voice query should be processed comprises:
if the first security level exceeds or equals the second security level, allowing processing of the voice query; and
if the first security level falls below the second security level, disallowing processing of the voice query.

12. The method of claim 11 wherein determining whether the voice query should be processed further comprises:
if the second security level exceeds a predefined threshold, verifying the user's identity using one or more authentication techniques different from an authentication technique used to initially determine the user's identity, before proceeding with processing of the voice query.

13. The method of claim 1 wherein determining whether the voice query should be processed is performed locally on the computing device.

14. The method of claim 1 wherein determining whether the voice query should be processed is performed, at least partially, on another device or system that is distinct from the computing device.

15. A non-transitory computer readable medium having stored thereon program code executable by a processor of a computing device, the program code comprising:
code that causes the processor to receive speech data corresponding to a voice query uttered by a user;
code that causes the processor to determine the user's identity and a query type of the voice query;
code that causes the processor to retrieve a first security level associated with the user's identity and a second security level associated with the query type; and
code that causes the processor to determine, based on the first security level and the second security level, whether the voice query should be processed.

16. The non-transitory computer readable medium of claim 15 wherein the code that causes the processor to determine whether the voice query should be processed comprises:
if the first security level exceeds or equals the second security level, code that causes the processor to allow processing of the voice query; and
if the first security level falls below the second security level, code that causes the processor to disallow processing of the voice query.

17. The non-transitory computer readable medium of claim 16 wherein the code that causes the processor to determine whether the voice query should be processed further comprises:
if the second security level exceeds a predefined threshold, code that causes the processor to verify the user's identity using one or more authentication techniques different from an authentication technique used to initially determine the user's identity, before proceeding with processing of the voice query.

18. A computing device comprising:
a processor; and
a non-transitory computer readable medium having stored thereon executable program code which, when executed by the processor, causes the processor to:
receive speech data corresponding to a voice query uttered by a user;
determine the user's identity and a query type of the voice query;
retrieve a first security level associated with the user's identity and a second security level associated with the query type; and
determine, based on the first security level and the second security level, whether the voice query should be processed.

19. The computing device of claim 18 wherein determining whether the voice query should be processed comprises:
if the first security level exceeds or equals the second security level, allowing processing of the voice query; and
if the first security level falls below the second security level, disallowing processing of the voice query.

20. The computing device of claim 19 wherein determining whether the voice query should be processed further comprises:
if the second security level exceeds a predefined threshold, verifying the user's identity using one or more authentication techniques different from an authentication technique used to initially determine the user's identity, before proceeding with processing of the voice query.
